(19) United States
(12) Patent Application Publication
(10) Pub. No.: US 2023/0148585 A1
(43) Pub. Date: May 18, 2023

(54) APPARATUS AND SYSTEMS FOR TREATING PLANTS

(71) Applicant: IOTREES PTY LTD, SILVAN, VICTORIA (AU)

(72) Inventors: Jon Singleton, MELBOURNE, VICTORIA (AU); John Fitzgibbon, SILVAN, VICTORIA (AU)

(21) Appl. No.: 17/918,007

(22) PCT Filed: Apr. 13, 2021
(86) PCT No.: PCT/AU2021/050330

§ 371 Date: Oct. 10, 2022

(30) Foreign Application Priority Data
Apr. 14, 2020 (AU) 2020901171

(51) Int. Cl. A01M 7/00; A01C 23/04; A01G 7/06; A01B 69/04; A01C 23/00; G05B 19/4155

(52) U.S. Cl. CPC A01M 7/0092; A01C 23/047; A01G 7/06; A01B 69/008; A01C 23/007; G05B 19/4155; G05B 2219/45013

(57) ABSTRACT

Apparatus, systems and methods for the application of water, fertilizers and herbicides to municipal plants, crop plants, indoor plants, nursery plants and the like. A self-powered mobile apparatus delivers a liquid agent. The apparatus has a reservoir for the agent and a dispenser, electronic plant identifier or geographic locator, and an electronic controller to control delivery of the agent based on an output of the electronic plant identifier or geographic locator, or an output of a remote electronic plant identifier or geographic locator.

### FIELD OF THE INVENTION

The present invention relates generally to the fields of plant maintenance and management. More particularly, but not exclusive, the invention relates to improved apparatus, systems and methods for the application of water, fertilizers and herbicides to municipal plants, crop plants, indoor plants, nursery plants and the like.

### BACKGROUND TO THE INVENTION

Municipal plants such as street trees are seen as an essential amenity in city, suburban and regional environments. Trees not only enhance the visual appeal of a street, but also provide much needed shade in the warmer months and homes for a range of animals and insects.

Local councils expend significant funds on planting, watering and otherwise maintaining street trees. Watering is a particularly labour-intensive activity given the need for at least one worker to physically visit each tree regularly to deliver water.

Supplementary watering is required for many of species of tree over the drier months, including natives, exotics, evergreen and deciduous, and the task is to deliver water efficiently in a sustainable way. Street trees present particular challenges in terms of watering. For example, tree roots planted within median and street structures have a limited water storage volume and limited catchment opportunity and therefore require more regular watering. Tree root distribution is highly variable and non-symmetrical, and accordingly it is possible that water is delivered to an area about the tree with little or no root structure. Access to root systems may be limited by hard surfaces such as pavements. In some settings tree roots in active competition with turf roots for irrigation water, and accordingly more water may be required to maintain the tree. Canopy interception of rainfall can be significant, and therefore dictate higher levels of irrigation. Compacted soils (particularly on nature strips) result in low water infiltration rates which may require a low rate of water delivery to avoid wastage. A street tree may already be stressed due to pests, disease, damage or environmental pressures.

For all plants, the species and age of the plant, extensiveness of the root system and the physical environment in which it grows presents significant challenges to those responsible for the watering of trees. Quite apart from the need to conserve water, overwatering can lead to waterlogging of the root system and fungal diseases especially for potted and indoor plants.

It is therefore a problem that plant water requirements are highly variable according to many factors, and accordingly it is highly preferred to implement customized watering regimes so as to properly supply a plant yet avoid wastage of water.

Further complication in determining the proper irrigation of a tree arises in that the tree may have a water well or a layer of mulch. Such trees may require less regular water, but are supplied with a greater volume of water on each occasion.

Thus, apart from the expense of regular watering, a further problem arises in that a worker manually delivering water to a tree may not be capable of discerning an appropriate amount of water and/or an appropriate delivery rate for a particular tree. Where a tree is not supported sufficiently by watering at least, the tree may die thereby forcing expenditure on tree removal and replacement.

Similar problems arise in maintaining plants in other spaces such as playgrounds, parks, botanic gardens, civic squares, theme parks, zoos and the like. Larger scale installations of indoor plant in facilities such as in offices, hospitals, libraries, cinemas, shopping centres, hotels, retail stores, educational institutions and even some domestic settings may also present the problem associated with properly watering or otherwise maintaining a large number of plants.

It is an aspect of the present invention to provide an improvement to prior art means for delivering water (and optionally other plant needs) to a plant. It is a further aspect of the present invention to provide a useful alternative to such prior art means.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In a first aspect, but not necessarily the broadest aspect, the present invention provides a mobile apparatus for delivering an agent to a plant, the mobile apparatus comprising: self-powered transportation means, a reservoir for holding an agent, a dispenser in operable connection with the reservoir, electronic plant identification means or geographic location means, and a controller, wherein the controller is configured to control delivery of the agent based on (i) an output of the electronic plant identification or geographic location means, or (ii) an output of a remote electronic plant identification or geographic location means.

In one embodiment of the first aspect, the agent is a compound in the form or a liquid, a liquid composition, a liquid mixture, a solid, a gas or a vapour.

In one embodiment of the first aspect, the agent is selected from the group consisting of water, an aqueous solution, a fertilizer, a pesticide, a herbicide, a plant growth regulator, a botanical medicament, and steam.

In one embodiment of the first aspect, the dispenser comprises an outlet that is positionable about a plant such that the agent is deliverable to the plant.

In one embodiment of the first aspect, the dispenser comprises a movable arm having the outlet incorporated therein or extending therefrom

In one embodiment of the first aspect, the mobile apparatus comprises two, three, four or more reservoirs, each reservoir capable of holding a different agent and the controller is configured to selectively control the delivery of each of the different agents to the dispenser.

In one embodiment of the first aspect, the electronic plant identification means is a reader configured to read a plant identifier associated with a plant.

In one embodiment of the first aspect, the electronic plant identification means is selected from the group consisting of a visual identifier, an audio identifier, an ultrasonic identifier, and an infrared identifier, a magnetic identifier, an electrical identifier, an electromagnetic identifier, a radio frequency identifier.

In one embodiment of the first aspect, the electronic plant identification means is an electromagnetic identifier and the strength of a signal emitted by the electromagnetic identifier is used to position the dispenser outlet in relation to a plant.

In one embodiment of the first aspect, the electronic plant identification means is a passive RFID tag.

In one embodiment of the first aspect, the mobile apparatus comprises a camera configured to output a signal used to position the dispenser outlet in relation to a plant.

In one embodiment of the first aspect, the electronic plant identification means is a camera configured to identify the plant per se or the environment about the plant using image recognition means.

In one embodiment of the first aspect, the reader comprises a data output and the controller is configured to receive a signal directly or indirectly from the data output, wherein the data output relates to plant identification and the controller controls delivery of the agent according to the data output.

In one embodiment of the first aspect, the geographic location means is operable by way of the global positioning satellite (GPS) system.

In one embodiment of the first aspect, the mobile apparatus comprises a wireless computer network interface configured to form a computer network connection.

In one embodiment of the first aspect, the computer network connection is with a remote computer server.

In one embodiment of the first aspect, the wireless computer network interface handles plant identification output from the reader or the camera, and/or geographical location data, and/or data for input to the controller.

In one embodiment of the first aspect, the wireless computer network interface is configured to connect to a LAN, WAN (including LoRa), a mobile telephony network, or the Internet.

In one embodiment of the first aspect, the wireless computer network interface is operable on a 5G mobile data network, or a successor mobile data network thereof.

In one embodiment of the first aspect, the mobile apparatus comprises one or more flow control means configured to commence, interrupt and/or regulate the output of an agent from the dispenser.

In one embodiment of the first aspect, the flow control means is a valve or a pump.

In one embodiment of the first aspect, the mobile apparatus comprises a computer processor configured to output instructions to the controller.

In one embodiment of the first aspect, the computer processor is the controller or is a part of the controller.

In one embodiment of the first aspect, the flow control means is operable to receive an instruction from the controller so as to commence, interrupt or regulate the output of an agent from the dispenser.

In one embodiment of the first aspect, the mobile apparatus comprises a sensor configured to sense a parameter of a plant or a plant environment.

In one embodiment of the first aspect, the parameter is selected from the group consisting of plant appearance, and soil moisture level.

In one embodiment of the first aspect, the mobile apparatus is configured to be electronically navigable so as to travel between a depot and a plant and/or between a first plant and a second plant.

In one embodiment of the first aspect, the mobile apparatus comprises GPS navigation means and being automatically navigable by way of the GPS navigation means.

In one embodiment of the first aspect, the mobile apparatus is partially or completely autonomously navigable.

In a second aspect, the present invention provides a system for delivering an agent to a plant, the system comprising: the mobile apparatus of embodiment of the first aspect, and a computer comprising a database having stored plant identifying information for a plurality of plants, and additional information in linked association therewith for each of the plurality of plants,

In one embodiment of the second aspect, the mobile apparatus comprises a wireless computer network interface and the computer comprising a database is a remote computer server in data communication with the network interface.

In one embodiment of the second aspect, the plant identifying information correlates with a plant identifiable by the plant identification means or with a plant location.

In one embodiment of the second aspect, the plant identifying information is sufficient to uniquely identify a plant amongst a plurality of plants.

In one embodiment of the second aspect, the additional information is selected from the group consisting of: plant species, plant age, plant size, plant location, agent requirement, agent application schedule, plant environment, and recent rainfall at plant location

In one embodiment of the second aspect, the system comprises a computer configured to determine the requirement for an agent based on additional information for an identified plant.

In one embodiment of the second aspect, the computer configured to determine the requirement for an agent based on additional information for an identified plant comprises an algorithm embodied in software, the algorithm configured to determine the requirement for an agent based on additional information for an identified plant.

In one embodiment of the second aspect, the system comprises a depot accessible by the mobile apparatus, the depot comprising a filling station configured to cause or allow refilling of the reservoir(s) of the mobile apparatus.

In one embodiment of the second aspect, the depot comprises a battery charger configured to cause or allow charging of a battery configured to power the mobile apparatus.

### BRIEF DESCRIPTION OF THE FIGURES

FIG. 1 is a block diagram of components of an exemplary mobile tree watering apparatus. In this apparatus trees are identified using an electronic reader.

FIG. 2 is a block diagram of components of an exemplary mobile tree watering apparatus. In this apparatus trees are identified using a geographical locator such as GPS.

FIG. 3 is a block diagram showing the flow of liquid agents through an exemplary mobile tree watering apparatus.

FIG. 4 illustrates an exemplary mobile tree watering apparatus delivering water to a street tree.

Unless otherwise indicated herein, features of the drawings labelled with the same numeral are taken to be the same features, or at least functionally similar features, when used across different drawings.

The drawings are not prepared to any particular scale or dimension and are not presented as being a completely accurate presentation of the various embodiments.

### DETAILED DESCRIPTION OF THE INVENTION AND PREFERRED EMBODIMENTS THEREOF

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments, or indeed any embodiment covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

As used herein, any positional terms such as “lateral”, “across”, “above”, “below”, “higher”, “lower”, “upward”, “downward”, “plan view” and the like are to be considered with reference to the apparatus as used in a normal upright position so as to roll over a surface and deliver an agent to a plant.

The present invention is predicated at least in part on the inventors' discovery that an autonomous mobile apparatus having a positionable water outlet is an improvement or at least a useful alternative to the prior art means for watering street trees such as tanker driven by a driver. In such prior art methods, the driver (or possibly a second worker) manually directs a watering hose onto the tree to deliver water before moving onto the next tree and repeating the process. The present invention (at least in some embodiments) extends beyond that broad discovery as more fully detailed infra.

The present invention will now be more fully described by reference to the non-limiting examples shown in the accompanying drawings.

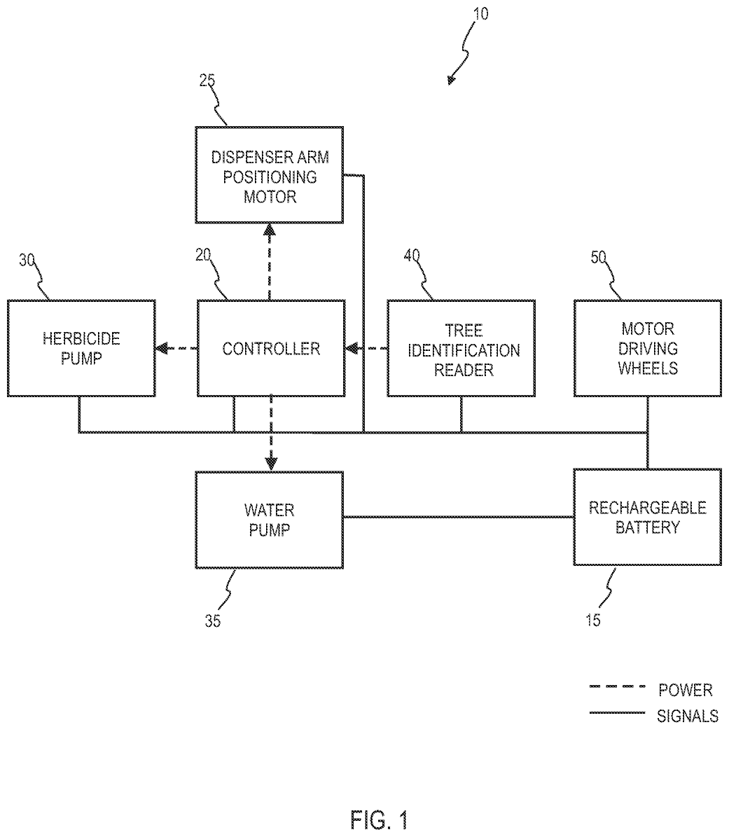

Turning firstly to FIG. 1, there is shown a block diagram of the electrical and electronic components of an exemplary mobile apparatus (10). As will be appreciated, the block diagram is intended to show the core components of the apparatus and is not intended to show all components required for operability.

All components of the apparatus (10) are powered by a rechargeable battery (15) as indicated by the solid connecting lines. A central component is the controller (20) which receives input signals (not drawn) and in turn outputs signals as indicated by the dashed connecting lines to the dispenser arm positioning motors (25), the herbicide pump (30), the water pump (35). The controller (20) receives signals from the tree identification reader (40). A motor (50) is provided to drive the apparatus wheels (not drawn), which in turn propel the apparatus (10) across the ground.

In broad terms, the apparatus (10) is propelled by the motor (50) along street until the tree identification reader detects and identifies a proximal tree (not drawn). Once the tree is identified, the controller (20) actuates the dispensing arm positioning motors (25) to extend the apparatus dispensing arm (not drawn) such that its terminus is about the base of identified tree. Once the terminus is positioned, the controller actuates an electric water pump (35) so as to cause water to be drawn from an on-board reservoir (not drawn) and output to the tree via a bulk nozzle on the dispensing arm terminus. Once a volume water is output, the controller (20) switches off the water pump (35) so as to cease output of water.

The controller (20) then actuates the herbicide pump (30) so as to dispense herbicide from a second on-board reservoir (not drawn). Again, the controller (20) switches the pump (30) on and then off to deliver the required volume. Herbicide is dispensed through a fine spray nozzle (not drawn) on the terminus of the dispensing arm about the base of the tree.

Considering the exemplary embodiment of FIG. 1 now in more detail, the tree identification reader (40) is in one embodiment operable either by way of some physical identification means disposed on or about a tree. The tree identification reader (40) may be configured to read identifying information from a physical identifier such as a tag which may emit an electrical, magnetic or electromagnetic signal. Alternatively, the tag may be readable by virtue of some visual appearance or audio signal output.

Although the tag is not part of the mobile apparatus (the tag being disposed on or about a tree to be treated by the apparatus) it is opportune at this point to nevertheless describe the tag given its functional relationship to the tree identification reader of the apparatus. The physical construction of the tag will typically be capable of bearing an environmental conditions to which it may be exposed. The most extreme conditions are anticipated to be direct sunlight, acid rain, snow, road salt, and sub-zero temperatures.

Suitably, the tag may be composed predominantly or completely from a metal such as stainless steel capable of withstanding harsh outdoor environmental conditions. A barcode or QR code may be laser etched onto the tag using a laser system such as the Epilog™ system of Epilog Laser Inc (CO, United States), such etching anticipated to maintain readability even after exposure to the elements.

Alternatively, a polymer having significant resistance to the elements may be used. Particularly, a polymer that is stabilised to oxidation, UV damage, thermal degradation, ozonolysis, acid/base damage and the like may be used. The tag may be printed with a QR code or barcode using a thermal transfer printer. Useful materials are thermosetting polymers that are irreversibly hardened by curing from a soft solid or viscous liquid prepolymer or resin. Curing is typically induced by heat or radiation and may be facilitated by high pressure, or facilitated by exposure to a catalyst. The resultant chemical reactions create extensive cross-linking between polymer chains to produce an infusible and insoluble polymer network. Exemplary polymers include polyester resin fiberglass systems, polyurethanes, polyurea/polyurethane hybrids, vulcanized rubber, Duroplast™ epoxy resin, vinyl ester resin. In some instances thermoplastics such as a high density polyethylene may be used.

In selecting materials for the tag, regard will typically be had to the possibility of leachates entering the environment. Accordingly, environmental conditions and storage conditions (including temperature, humidity, and precipitation) will generally be considered when selecting suitable materials.

In some embodiments, the tag may be tethered to the tree allowing for limited or no contact with the tree.

In some embodiments, the tag comprises a protective cover to inhibit the effect of adverse environment conditions. The cover may be generally transparent allowing for the transmission of light and other electromagnetic radiation or sound. This allows for the tag to nevertheless be read by the tree identification reader (40).

The tag may configured for physical association with the tree or other substrate to be tagged. The means for physical association may be selected so as to limit the possibility for removal so as to give confidence that each tree can be reliably identified and watered appropriately.

The tag may be attached directly to a tree trunk, using barbs or similar engagement means. In some embodiments, the tag is attached to the tree using a tether of flexible elongate material. In some circumstances, the tether may be passed around the trunk to form a loop integral with the tag.

The identifying information born by the tag (and readable by the tree identification reader) may be optical in nature. Suitable optical means include alphanumeric data that is readable by optical character recognition software, or be a barcode or a QR code. Other optical means are not excluded, including optical means not yet developed but available in the future.

Alternatively, the identifying information born by the tag may be non-optical in nature and may be in electronic form. An exemplary non-optical form of identifying information is a radio frequency identification (RFID) tag. Typically, a passive RFID tag is used, which includes an antenna and memory circuit. The memory circuit is powered by extracting energy from the interrogation signal transmitted by the RFID reader. An active RFID tag is less preferred given the need for a source of electrical energy (such as a battery) to power the transmission of RF signals from the tag to the reader.

The tree identification reader for the RFID tag (or any other tree identification means) is typically positioned on or about the mobile apparatus to favour proximity to the tag to the reader. For example, the reader may be located on the exterior of the apparatus, on a lower lateral surface and on a side facing a pavement where trees are to be treated. Alternatively, the reader may be disposed at the end of a flexible pole that is biased normally directly outwardly from the mobile apparatus but is easily deflectable by contact with an obstacle such as a pedestrian, a vehicle, or a trash bin.

In some embodiments, the tree identification reader does not rely on a tag, and instead is able to utilize visual features of a tree, or the environment of a tree to make an identification. In that regard the reader may be a camera configured to image the tree and/or its environment to make a positive identification. In such an embodiment, image processing software may locally or remotely compare the image to a database of images (or extractions thereof) with the aim of matching the tree under consideration with a known tree on the database. In addition or alternatively, the surroundings of a tree may be used for identification of the tree. Objects such as proximal building facades, fences, street furniture, house numbers, letter boxes, signage, power poles and the like may be used to make or assist in the image-based identification of a tree.

The embodiment of FIG. 1 comprises controller-operable motors configured to position the dispensing arm. Suitable motors are electrically driven, for example by an on-board battery. Generally, the function of the motors is to move the arm from a retracted position to an extended position to allow water (or another agent) to be deposited on or about a tree in need thereof. The dispenser arm may only require a single motor (for example to extend and retract the arm), but will typically have one or more further motors to make fine adjustments to the position. For example, motors may be used to rotate the arm along an arc (in plan view) and/or angle the arm to the ground (in lateral view) and/or bend the arm about a pivot point so as to best direct the water to the tree.

The controller (20) in the embodiment of FIG. 1 functions to send signals to the pumps (30, 35) and the dispenser arm positioning motor (25). For example, the signal may be the simple supply of fixed voltage to a relay of the pump or motor concerned, the relay being actuated so as to close an electrical power supply circuit thereby causing the pump or motor to commence operation. The signal may be more complex, and may be in the form of a variable voltage capable of modulating the speed of a motor or a pump. Further complexity may be provided by way of a digital signal capable of carrying step-wise instructions such as “operate at full speed for 30 seconds, reduce speed to 50% for 5 seconds, and stop”.

In the embodiment of FIG. 1, the controller (20) has an input from the tree identification reader (40). In a basic embodiment of the invention, the tree identification reader (40) simply identifies the presence of a tree proximal to the mobile apparatus (and more particularly proximal to the outlet of the dispensing arm) and under such conditions sends a signal to the water pump (35) to deliver a predetermined volume of water. In other embodiments a particular tree is identified and the requirement for water and/or herbicide and/or any other agent for that particular tree is determined by reference to an on-board or remote computer. Where contact with a remote computer is required, it will be understood that the mobile apparatus will comprise wireless computer networking hardware and software.

Where a tree has an identifier and the mobile apparatus (via the tree identification reader) has read the identifier, the identifier may be used to locate a relational database entry on a local or remote computer file server. For example, the identifier may be captured by the reader and input to dedicated application software. The dedicated application software is configured to instruct a computer of the mobile apparatus to make network communication with a predetermined computer server holding a series of identifiers and additional plant information in linked association in the form of a relational database. Thus, the application software, having inputted the identifier of the tag and being connected to the remote computer file server, is able to access additional plant information in linked-association with the identifier. For example, where the identifier is 789456382 the relational database has an entry 789456382, and the information in linked association is the watering schedule information for the tagged plant was originally tagged, and based on the watering schedule an instruction is communicated to the controller to deliver water to the tagged plant.

The controller may or may not comprise a processor, although for many applications a processor is present to form network communications with a remote computer, or to hold additional plant information on-board (in combination with electronic memory), or to execute an algorithm in order to determine which agent and the amount of each agent is to be delivered to an identified plant. The processor may be instructed by suitable software held in an electronic memory module.

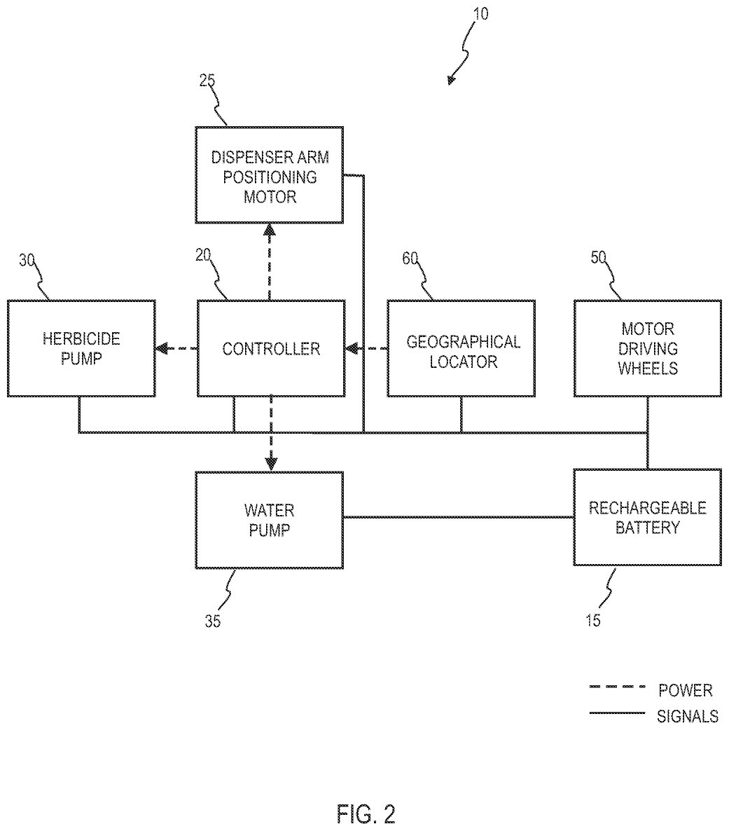

An alternative embodiment to that of FIG. 1 is shown in FIG. 2, whereby the tree identification reader (40) is replaced by an electronic geographical locator (60). In the embodiment of FIG. 2, a tree is identified by reference to its geographical location rather than any identifier tag. A useful means for geographical location in this context is the GPS system which is capable of accurately determining the location of the mobile apparatus with sufficient precision. For example, a particular tree may have a certain latitude and longitude, with those parameters acting as a surrogate identifier for the purposes of the present invention.

While GPS may be sufficient to locate the mobile apparatus in sufficient proximity to a tree, further means may be used to precisely position a water outlet such that water is accurate delivered onto or about the tree. For example, a camera may be used to allow a remote operator to guide the water outlet. Alternatively, the camera may be used to output video input into software suitable for guiding the water outlet.

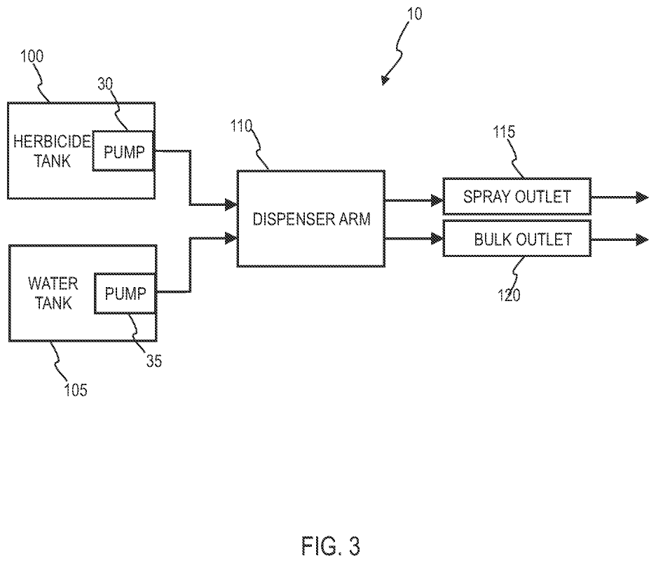

Turning now to FIG. 3, there is shown a diagram of agent movement (i.e. water and herbicide) through the mobile apparatus (10). The apparatus has a herbicide tank (100) with a dedicated pump (30) and a water tank (105) having a dedicated pump (35). Each pump outputs to a dedicated conduit (as indicated by the arrowed lines), each of the dedicated conduits extending through the dispenser arm (110). The herbicide is output via a spray outlet (115) and the water via a bulk outlet (120), the differential in outlet hardware being due to the need to spray herbicide onto the foliage of any weeds about the tree base.

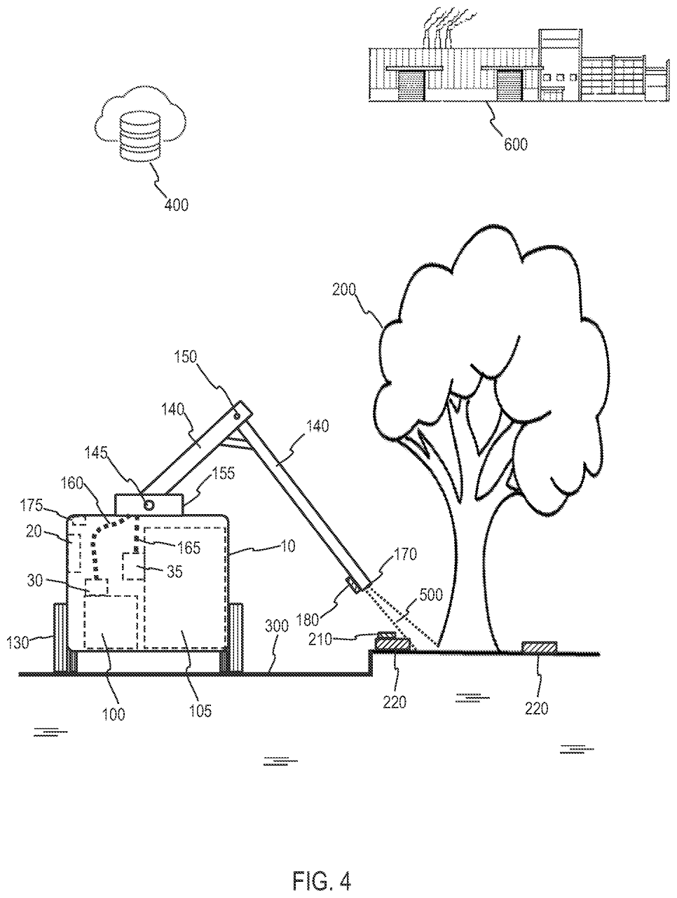

Reference is now made to FIG. 4 showing the mobile apparatus (10) delivering water to a street tree (200). The mobile apparatus (10) rolls on four wheels (one marked 130) along a public street (300). The apparatus (10) has an articulated arm (140) that pivots at two points (145, 150) by hydraulic means, and is rotated by a motor acting on the mounting base (155). As drawn, the arm is shown in a generally extended configuration suitable for watering the street tree (200).

Housed inside the apparatus is a water tank (105), associated pump (35), and associated conduit (160). Also housed is a herbicide tank (100), associated pump (30), and associated conduit (165). Each of the conduits (160, 165) is flexible and extend through the articulated arm (140) to about its terminus (170) where each separately open to the environment.

The apparatus (10) further houses a processor/controller (20) which controls the pumps (30, 35) and therefore the flow of water and herbicide from the tanks (100, 105) to the terminus (170) and to the environment. A wireless computer networking interface module (175) operable on the mobile 5G protocol is provided for the processor/controller to send and receive data to a computer cloud server (400). The cloud server (400) comprises a relational database having a unique record for the street tree (200) and also other trees (not drawn) serviced by the mobile apparatus (10). The database record for the street tree includes species, age, location and date last watered. The cloud server (400) further comprises a software algorithm that calculates the amount of water to be delivered to the tree (200) based on species, age, time since date last watered and also location sensitive environmental information such as recent rainfall, impending rainfall, recent ambient temperature, and recent ambient humidity.

The mobile apparatus (10) further comprises a camera (180) configured to image a tree identification plate (210) which is fastened to the concrete tree surround (220). The tree identification plate (210) has a QR code etched onto its upwardly facing surface so as to be visible to the camera (180).

When the mobile apparatus is proximal to the street tree (200) (as drawn) the camera (180) captures the QR code on the tree identification plate (210). The image is uploaded by the wireless computer networking interface module (175) to the cloud server (400). The QR code is decoded by the server (400) to provide a tree identification number. The server (400) interrogates the relational database for that tree identification number and utilises the record information (species, age, time since date last watered, location) and also location sensitive environmental information (recent rainfall, impending rainfall, recent ambient temperature, recent ambient humidity) as input for a water volume calculation algorithm executable on the server (400). The calculated volume is communicated to the processor/controller (20) of the mobile apparatus (10) via the wireless computer networking interface module (175). The processor/controller sends an instruction to the water pump (35) the calculated volume to the tree (200) as a stream (500) direct to the tree base.

In this embodiment, the camera (180) functions also to assess the tree (200) environs. The camera (180) captures an image of the ground surrounding the tree (200), the image being transmitted to the cloud server (200) via the wireless computer networking interface module (175) for software-based image analysis. The image analysis software may be configured to detect the presence of weeds, and where weeds are detected a dose of herbicide from the tank (100) may be sprayed onto the ground surrounding the tree (200).

The camera (180) may function further to sense the wetness or dryness of the ground surrounding the tree (200) on the basis of soil colour, for example. Furthermore, the colour of or density of the tree (200) foliage may be sensed by the camera, such information may be input into an algorithm to determine whether or not the tree (200) is suffering distress from a lack of sufficient water. The soil and tree condition information may be used by the algorithm to increase or decrease a standard amount of water deliverable to the tree (200) so as customize the watering for the tree (200) and its present condition.

After delivering water (and optionally herbicide) to the tree (200) the mobile apparatus rolls to further street trees requiring treatment. Each of the further trees has its own unique QR code and therefore its own unique database record on the cloud server (400). Accordingly, each tree may receive a customized amount of water (and optionally herbicide).

The mobile apparatus (10) is autonomously navigable and powered by a rechargeable lithium ion battery which drive an electric motor which drives two of the wheels (130). Of course, after treating a number of trees the battery may require recharging and/or the tanks (100, 105) may require refilling. The mobile apparatus may automatically navigate to a depot (600) having a battery charger and tank refilling station to replenish before setting out again to treat yet further trees.

Those skilled in the art will appreciate that the invention described herein is susceptible to further variations and modifications other than those specifically described. It is understood that the invention comprises all such variations and modifications which fall within the spirit and scope of the present invention.

While the invention has been disclosed in connection with the preferred embodiments shown and described in detail, various modifications and improvements thereon will become readily apparent to those skilled in the art. For example, the invention has been described mainly by reference to the delivery of water and liquid herbicide. However, other agents such as a fertilizer, a pesticide, a plant growth regulator, a botanical medicament, or steam (to kill weeds without a chemical herbicide) may be delivered. The apparatus may be configured to deliver only one agent, or any combination of two, three, four, five, six, seven, eight, nine or ten agents.

The agent may be any flowable substance include a slurry, a powder or a granulated material. In some cases, a pump or a pump or a valve may not be a suitable flow control means. For example, where the agent is a granulated substance (such as a slow release fertilizer) the granulated substance may be delivery to the tree by a gravity feed means, and in which case flow may be controlled by a trap door opening and closing. Alternatively a rotation-controllable Archimedes screw device may be used.

The exemplified embodiments of the mobile apparatus may be autonomous, relying only on computer-generated instructions to function, optionally with the assistance of one or more algorithms. It is contemplated, however, that some human intervention may be desired or required in the course of operation. For example, a human may geographically guide the apparatus from a remote control room for some or all of its journey. Furthermore, a human may view a camera image of a plant to determine the volume of water required or any other treatment that should be administered.

Apart from application to the treatment of street trees, the present invention may be useful in any installation whereby a plurality of plants require routine care by the delivery of an agent including playgrounds, parks, botanic gardens, civic squares, theme parks, zoos, offices, hospitals, libraries, cinemas, shopping centres, hotels, retail stores, educational institutions, domestic settings, plant nurseries, tree growing farms, edible produce farms, and orchards.

Accordingly, the spirit and scope of the present invention is not to be limited by the exemplary embodiments herein, but is to be understood in the broadest sense allowable by law.

1. A mobile apparatus for delivering an agent to a plant, the mobile apparatus comprising:
self-powered transportation means,
a reservoir for holding an agent,
a dispenser in operable connection with the reservoir,
electronic plant identification means or geographic location means, and
a controller wherein the controller is configured to control delivery of the agent based on
(i) an output of the electronic plant identification or geographic location means, or (ii) an output of a remote electronic plant identification or geographic location means.

2. (canceled)

3. The mobile apparatus of claim 1, wherein the agent is selected from the group consisting of water, an aqueous solution, a fertilizer, a pesticide, a herbicide, a plant growth regulator, a botanical medicament, and steam.

4. (canceled)

5. The mobile apparatus of claim 1, wherein the dispenser comprises a movable arm having the outlet incorporated therein or extending therefrom, the outlet being positionable about a plant such that the agent is deliverable to the plant.

6. The mobile apparatus of claim 1, comprising two, three, four or more reservoirs, each reservoir capable of holding a different agent and the controller is configured to selectively control the delivery of each of the different agents to the dispenser.

7. The mobile apparatus of claim 1, wherein the electronic plant identification means comprises a reader configured to read a plant identifier associated with a plant.

8. The mobile apparatus of claim 1, wherein the electronic plant identification means is selected from the group consisting of a visual identifier, an audio identifier, an ultrasonic identifier, and an infrared identifier, a magnetic identifier, an electrical identifier, an electromagnetic identifier and the strength of a signal emitted by the electromagnetic identifier is used to position the dispenser outlet in relation to a plant, a radio frequency identifier.

9. (canceled)

10. (canceled)

11. The mobile apparatus of claim 1, comprising a camera configured to output a signal used to position the dispenser outlet in relation to a plant.

12. The mobile apparatus of claim 1, wherein the electronic plant identification means comprises a camera configured to identify the plant per se or the environment about the plant using image recognition means.

13. The mobile apparatus of claim 1, wherein the reader comprises a data output and the controller is configured to receive a signal directly or indirectly from the data output, wherein the data output relates to plant identification and the controller controls delivery of the agent according to the data output.

14. (canceled)

15. The mobile apparatus of claim 1, comprising a wireless computer network interface configured to form a computer network connection with a remote computer server, and the wireless computer network interface handles plant identification output from the reader or the camera, and/or geographical location data, and/or data for input to the controller.

16. (canceled)

17. (canceled)

18. (canceled)

19. (canceled)

20. The mobile apparatus of claim 1, comprising one or more flow control means configured to commence, interrupt and/or regulate the output of an agent from the dispenser.

21. (canceled)

22. (canceled)

23. (canceled)

24. The mobile apparatus of claim 20, wherein the flow control means is operable to receive an instruction from the controller so as to commence, interrupt or regulate the output of the agent from the dispenser.

25. The mobile apparatus of claim 1, comprising a sensor configured to sense a parameter of a plant or a plant environment.

26. (canceled)

27. The mobile apparatus of claim 1, configured to be electronically navigable so as to travel between a depot and a plant and/or between a first plant and a second plant.

28. (canceled)

29. The mobile apparatus of claim 1, wherein the mobile apparatus is partially or completely autonomously navigable.

30. A system for delivering an agent to a plant, the system comprising: a mobile apparatus for delivering an agent to a plant, the mobile apparatus
comprising:
self-powered transportation means,
a reservoir for holding an agent,
a dispenser in operable connection with the reservoir,
electronic plant identification means or geographic location means,
a controller, wherein the controller is configured to control delivery of the agent based on (i) an output of the electronic plant identification or geographic location means, or (ii) an output of a remote electronic plant identification or geographic location means, and
a wireless computer network interface; and
a remote computer server in communication with the network interface and comprising a database having stored plant identifying information for a plurality of plants, and additional information in linked association therewith for each of the plurality of plants.

31. (canceled)

32. The system of claim 30, wherein the plant identifying information correlates with a plant identifiable by the plant identification means or with a plant location.

33. The system of claim 30, wherein the plant identifying information is sufficient to uniquely identify a plant amongst a plurality of plants.

34. The system of claim 30, wherein the additional information is selected from the group consisting of: plant species, plant age, plant size, plant location, agent requirement, agent application schedule, plant environment, and recent rainfall at plant location.

35. The system of claim 30, wherein the remote computer server comprises an algorithm embodied in software stored in a memory, the algorithm configured to determine a requirement for an agent based on additional information for an identified plant.

36. (canceled)

37. (canceled)

38. (canceled)
